(19) United States
(12) Patent Application Publication
(10) Pub. No.: US 2024/0254735 A1
(43) Pub. Date: Aug. 1, 2024

(54) SYSTEMS TO PASSIVELY CAPTURE WATER FROM AIR AND RELATED METHODS

(71) Applicant: Saudi Arabian Oil Company, Dhahran (SA)

(72) Inventors: Layan Alaeddin AlSharif, Dhahran (SA); Abdulrahman Mohammed Alqahtani, Khobar (SA)

(21) Appl. No.: 18/104,068

(22) Filed: Jan. 31, 2023

(51) Int. Cl. E03B 3/28; B01D 15/26; E04D 1/02

(52) U.S. Cl. CPC E03B 3/28; B01D 15/26; E04D 1/02

(57) ABSTRACT

The disclosure provides systems to passively capture water from air, and related methods. The systems can be used as a roof tile.

### FIELD

The disclosure provides systems to passively capture water from air, and related methods. The systems can be used as a roof tile.

### BACKGROUND

Sustainable water harvesting solutions can be used to address challenges related to water scarcity.

### SUMMARY

The disclosure provides systems to passively capture water from air, and related methods. The systems can be used as a roof tile.

The systems and methods can allow for water production and collection without a connection to an external water grid. The water can be supplied during part of the day or throughout the entire day (e.g., day and night). The systems and methods can be used to collect water for human consumption, storage and/or agricultural use, as well as other uses. The systems and methods can be used as part of a cooling strategy by promoting plant growth for shade and/or evapotranspiration.

The systems and methods can have relatively good water collection efficiencies and/or use relatively little space relative to certain other methods of harvesting water from air, such as mesh nets. The systems and methods can be relatively inexpensive to manufacture and install.

In a first aspect, the disclosure provides a system, including a substrate including a support body, a first curved surface, a second curved surface and a third curved surface; a plurality of superhydrophilic regions; and a plurality of superhydrophobic regions. The support body includes a top surface, a first edge and a second edge opposite the first edge. The first curved surface includes a concave side including a protrusion attaching the first curved surface to a center of the top surface of the support body, and a convex side. The second curved surface includes a concave side and a convex side. The second curved surface is attached to the first edge of the support body such that the concave side of the second curved surface faces the top surface of the support bod. The third curved surface includes a concave side and a convex side. The third curved surface is attached to the second edge of the support body such that the concave side of the third curved surface faces the top surface of the support body. The plurality of superhydrophilic regions are supported by the convex side of the first, second and third curved surfaces. The plurality of superhydrophobic regions are supported by the convex side of the first, second and third curved surfaces. The superhydrophilic regions are raised relative to the superhydrophobic regions.

In some embodiments, the plurality of superhydrophilic regions and superhydrophobic regions are arranged in alternating rows parallel to a curvature of the first, second and third curved surfaces.

In some embodiments, the superhydrophilic regions form bumps and the superhydrophobic regions form valleys.

In some embodiments, the superhydrophobic regions have an apex angle of 0° to 90°.

In some embodiments, the top surface of the support body has a concave shape between points of attachment of the protrusion and the second and third curved surfaces.

In some embodiments, the plurality of superhydrophilic regions have a length of 0.01 cm to 40 cm.

In some embodiments, the plurality of superhydrophilic regions have a width of 0.01 cm to 15 cm.

In some embodiments, the plurality of superhydrophobic regions have a surface length of 0.02 cm to 40 cm.

In some embodiments, the plurality of superhydrophobic regions have a width of 0.02 cm to 15 cm.

In some embodiments, the first, second and third curved surfaces include a hydrogel disposed on the convex side. The hydrogel absorbs water at a first temperature and the hydrogel releases absorbed water at a second temperature greater than the first temperature.

In some embodiments, the first temperature is less than 32° C. and the second temperature is greater than 32° C.

In some embodiments, the superhydrophilic regions include titanium oxide and the superhydrophobic regions include heptadecafluorodecyl-trimethoxysilane modified titanium oxide.

In some embodiments, the system has a length of 1.5 cm to 40 cm.

In some embodiments, the system has a width of 1 cm to 26.5 cm.

In some embodiments, the system has a height of 0.05 cm to 2.5 cm.

In a second aspect, the disclosure provides a structure including a roof. The roof includes a plurality of systems of the disclosure.

In a third aspect, the disclosure provides a method of collecting water, using a system of the disclosure.

In certain embodiments, the method further includes absorbing water using the hydrogel at the first temperature.

In certain embodiments, the method further includes releasing water absorbed by the hydrogel at the second temperature.

### BRIEF DESCRIPTION OF THE FIGURES

FIG. 1A depicts a first view of a schematic of a system.

FIG. 1B depicts a second view of a schematic of a system.

FIG. 1C depicts a schematic of a single superhydrophilic region.

FIG. 2 depicts a computer-generated image made using computer aided design software.

FIG. 3 depicts a schematic for a process of collecting and transferring water.

FIG. 4 depicts a schematic for a structure.

### DETAILED DESCRIPTION

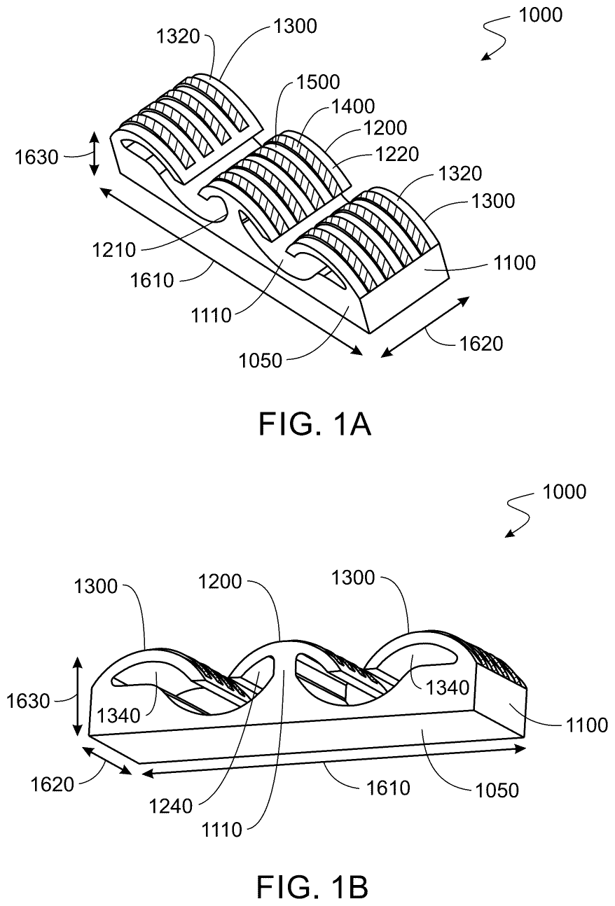

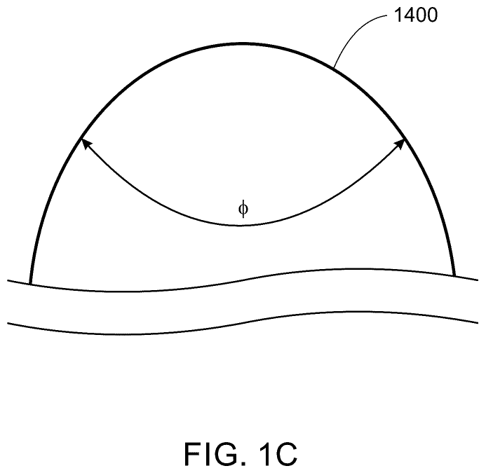

FIGS. 1A and 1B depict different perspective views of a schematic of a system 1000. The system 1000 includes a substrate 1050 that includes a support body 1100 supporting curved surfaces 1200 and 1300. The curved surface 1200 includes a convex side 1220 and a concave side 1240. Similarly, the curved surfaces 1300 include convex sides 1320 and concave sides 1340. The curved surface 1200 attaches to the center of the support body 1100 via a protrusion 1210 that extends from the concave side 1240. The curved surfaces 1300 directly attach to opposite ends of the support body 1100. The support body 1100 includes concave regions 1110 between the attachment points of the curved surfaces 1200 and 1300 to the support body 1100.

The convex sides 1220 and 1320 support superhydrophilic regions 1400 and superhydrophobic regions 1500 (see discussion below). The superhydrophilic regions 1400 and the superhydrophobic regions 1500 form alternating rows on the convex sides 1220 and 1320 that run parallel to the curvature of the curved surfaces 1200 and 1300. The superhydrophilic regions 1400 are raised relative to the superhydrophobic regions 1500. The superhydrophilic regions 1400 are in the form of bumps and the superhydrophobic regions 1500 are in the form of valleys. The bumps and valleys include curved surfaces. Without wishing to be bound by theory, it is believed the curved surfaces of the bumps, valleys and inner folds (the concave sides 1240 and 1340) provide a relatively high surface area, which can increase water capture rates.

A temperature-responsive material (e.g., a hydrogel) is disposed on the concave sides 1240 and 1340. The temperature-responsive material (e.g., a hydrogel) can absorb water at a first temperature and release the stored water at a second temperature greater than the first temperature. For example, the temperature-responsive material can absorb water at night and release water during the day upon heating by solar heat.

Without wishing to be bound by theory, it is believed that the alternating superhydrophilic regions 1400 and superhydrophobic regions 1500, with the superhydrophilic regions 1400 raised relative to the superhydrophobic regions 1500, assist the system 1000 in passively capturing water from air. Water droplets can be captured by the superhydrophilic regions 1400, grow, and coalesce with one another. Gravity then causes captured water to move to the superhydrophobic regions 1500. The water on the superhydrophobic regions 1500 move towards end points (e.g., a storage unit, a bucket, a plant (see discussion below)). New droplets can continuously condense on the superhydrophilic regions 1400.

FIG. 1C depicts a single superhydrophilic region 1400, in the form of a bump, with the apex angle (φ) indicated. Without wishing to be bound by theory, the cycle of water droplet nucleation, growth, and gravitational falling repeats with a specific average period corresponding to a water collection rate. To optimize the collection rate, the system 1000, including the superhydrophilic regions 1400 and superhydrophobic regions 1500 needs to be modified to continuously remove deposited droplets. Water droplets attached to the hydrophilic bumps experience a Laplace pressure difference, ΔP

$$Δ P = \frac{dP}{dz} {\vert}_{Ω} = - \frac{2 γ}{{( r + {R}_{0} )}^{2}} sin α \qquad Eq . 1$$

where Ω is droplet volume, γ is surface tension, r is the local radius, R₀ is the droplet radius and α is the half apex angle. The Laplace pressure difference drives droplets towards the valley, thus re-exposing the hydrophilic surface to more incoming vapor. Following Eq. 1, to increase the water collection rate, the apex angle (φ) of the superhydrophilic regions 1400 can be reduced within the constraints of the fabrication process and mechanical strength of the material. In some embodiments, the apex angle of the superhydrophilic regions 1400 is at least 0° (e.g., at least 5°, at least 10°, at least 15°, at least 20°, at least 25°, at least 30°, at least 35°, at least 40°, at least 45°, at least 50°, at least 55°, at least 60°, at least 65°, at least 70°, at least 75°, at least 80°, at least 85°) and/or at most 90° (e.g., at most 85°, at most 80°, at most 75°, at most 70°, at most 65°, at most 60°, at most 55°, at most 50°, at most 45°, at most 40°, at most 35°, at most 30°, at most 25°, at most 20°, at most 15°, at most 10°, at most 5°).

The superhydrophilic regions 1400 can be formed of any appropriate superhydrophilic material and can be applied using any appropriate method. For example, the superhydrophilic regions 1400 can include titanium oxide (TiO₂) and can be fabricated by depositing a TiO₂ slurry by spin-coating.

The superhydrophobic regions 1500 can be formed of any appropriate superhydrophobic material and can be applied using any appropriate method. For example, the superhydrophobic regions 1500 can include heptadecafluorodecyl-trimethoxysilane (FAS) modified TiO₂ films and can be fabricated by depositing a TiO₂ film (e.g., fabricated by depositing a TiO₂ slurry by spin-coating) on the convex sides 1220 and 1320, followed by treatment with FAS.

In certain embodiments, the substrate 1050 is composed of a superhydrophobic material and the superhydrophilic regions 1400 can be formed using any appropriate method. In certain embodiments, the superhydrophilic regions 1400 are formed by shaped-patterned photomasks with selective UV light illumination. For example, the substrate (the support body 1100 and the curved surfaces 1200 and 1300) can include FAS modified TiO₂ and shaped-patterned photomasks with selective UV light illumination is applied making the illuminated regions superhydrophilic.

FIGS. 1A and 1B depict the superhydrophilic regions 1400 and superhydrophobic regions 1500 arranged in rows on the curved surfaces 1200 and 1300 parallel to the direction of the curve. Without wishing to be bound by theory, it is believed that this configuration facilitates the coalescence of water droplets captured from air. However, the use of selective illumination allows for other configurations of the superhydrophilic regions 1400 and superhydrophobic regions 1500 to be created on the curved surfaces 1200 and 1300. The superhydrophilic regions 1400 and superhydrophobic regions 1500 can be arranged such that they exhibit high-contrast wettability, such as in a kirigami structure or with patterned micropillars.

In some embodiments, the superhydrophilic regions 1400 have a water contact angle of at least 0° (e.g., 1º, at least 2°, at least 3º, at least 4°, at least 5°, at least 6°, at least 7º, at least 8°, at least 9°) and/or at most 10° (e.g., at most 9°, at most 8°, at most 7°, at most 6°, at most 5°, at most 4°, at most 3°, at most 2°, at most 1º). In some embodiments, the superhydrophobic regions 1500 have a water contact angle of at least 150° (e.g., at least 155°, at least 160°, at least 165°, at least 170°, at least 175°) and/or at most 180° (e.g., at most 175°, at most 170°, at most 165°, at most 160°, at most 155°).

In general, the temperature-responsive material on the concave sides 1240 and 1340 is viscoelastic allowing it to be shaped into desired structures and providing relatively good processability and compatibility with various manufacturing techniques. In some embodiments, the temperature-responsive material (e.g., hydrogel) can be spray coated onto inner surfaces of the system 1000, such as the concave sides 1240 and 1340, for example, after the superhydrophilic regions 1400 and superhydrophobic regions 1500 are fabricated.

In some embodiments, the temperature-responsive material is a hydrogel. Examples of hydrogels include poly(N-isopropylacrylamide) (PNIPAM) hydrogels. Without wishing to be bound by theory, it is believed that the hydrogels use photothermal converters to elevate the temperature of the gel body, thus inducing gel volumetric contraction and water release. The relatively high swelling ratio of the hydrogel allows it to continuously adsorb water collected by the system 1000 and store it. During the day, under sunlight irradiation, the hydrogel can release liquid water when the temperature is higher than the lower critical solution temperature (LCST) (e.g., 30-32° C.). The LCST triggers a hydrophilic-hydrophobic transition and can be tunable depending on the surrounding environment. In certain embodiments, the presence of a salt can alter the LCST of the temperature responsive material (e.g., hydrogel). In certain embodiments, the presence of a salt can reduce the LCST of the temperature responsive material (e.g., hydrogel).

Without wishing to be bound by theory, the temperature responsive material (e.g., hydrogel) will absorb water below its lower critical solution temperature (LCST) and release water above its LCST. The LCST value is tunable and depends on polymer concentration and degree of polymerization. For example, PNIPAM-based hydrogels exhibit a LCST of 30-32° C., which can be modified by copolymerizing with hydrophobic or hydrophilic polymers. Additionally, the temperature responsive material (e.g., hydrogel) will release water when the temperature is higher than its LCST, up to its glass transition temperature (T_{glass}). For example, PNIPAM polymers have T_{glass} in the range of 150-360° C. In some embodiments, the LCST can be altered by incorporating N-tert-butylacrylamide (NtBAAm), chain transfer agents, and/or monomers that affect the hydrophobicity/hydrophilicity of the temperature responsive material (e.g., hydrogel).

In certain embodiments, the temperature responsive material absorbs water at a temperature of at least 0 (e.g., at least 5, at least 10, at least 15, at least 20, at least 25, at least 30, at least 32) ° C. and/or at most 34 (e.g., at most 32, at most 30) ° C. In certain embodiments, the temperature responsive material releases water at a temperature of at least 30 (e.g., at least 32, at least 34) ° C. and/or at most 360 (e.g., at most 350, at most 300, at most 250, at most 200, at most 150) ° C.

In some embodiments, the system 1000 has a length 1610 of at least 1.5 (e.g., at least 2, at least 5, at least 10, at least 15, at least 20, at least 25, at least 30, at least 35) cm and/or at most 40 (e.g., at most 35, at most 30, at most 25, at most 20, at most 15, at most 10, at most 5) cm. In some embodiments, the system 1000 has a width 1620 of at least of at least 1 (e.g., at least 2, at least 5, at least 10, at least 15, at least 20, at least 25) cm and/or at most 26.5 (e.g., at most 25, at most 20, at most 15, at most 10, at most 5) cm. In some embodiments, the system 1000 has a height 1630 of at least 0.05 (e.g., at least 0.1, at least 0.2, at least 0.5, at least 1, at least 1.5, at least 2) cm and/or at most 2.5 (e.g., at most 2, at most 1.5, at most 1, at most 0.5, at most 0.2, at most 0.1) cm.

In some embodiments, superhydrophilic regions 1400 have a length (parallel to 1610) of at least 0.01 (e.g., at least 0.02, at least 0.05, at least 0.1, at least 0.2, at least 0.5, at least 1, at least 2, at least 5, at least 10, at least 15, at least 20, at least 25, at least 30, at least 35) cm and/or at most 40 (e.g., at most 35, at most 30, at most 25, at most 20, at most 15, at most 10, at most 5, at most 2, at most 1, at most 0.5, at most 0.2, at most 0.1) cm. In some embodiments, the superhydrophilic regions 1400 have a width (parallel to 1620) of at least of at least 0.01 (e.g., at least 0.02, at least 0.05, at least 0.1, at least 0.2, at least 0.5, at least 1, at least 2, at least 5, at least 10) cm and/or at most 15 (e.g., at most 10, at most 5, at most 2, at most 1, at most 0.5, at most 0.2, at most 0.1) cm. In some embodiments, the superhydrophilic regions 1400 have an area of at least 0.0001 (e.g., at least 0.001, at least 0.01, at least 0.1, at least 1, at least 10, at least 100) cm² and/or at most 600 (e.g., at most 100, at most 10, at most 1, at most 0.01, at most 0.001) cm².

In some embodiments, the superhydrophobic regions 1500 have a length (parallel to 1610) of at least 0.02 (e.g., at least 0.05, at least 0.1, at least 0.2, at least 0.5, at least 1, at least 2, at least 5, at least 10, at least 15, at least 20, at least 25, at least 30, at least 35) cm and/or at most 40 (e.g., at most 35, at most 30, at most 25, at most 20, at most 15, at most 10, at most 5, at most 2, at most 1, at most 0.5, at most 0.2, at most 0.1) cm. In some embodiments, the superhydrophobic regions 1500 have a width (parallel to 1620) of at least of at least 0.02 (e.g., at least 0.05, at least 0.1, at least 0.2, at least 0.5, at least 1, at least 2, at least 5, at least 10) cm and/or at most 15 (e.g., at most 10, at most 5, at most 2, at most 1, at most 0.5, at most 0.2, at most 0.1) cm. In some embodiments, superhydrophobic regions 1500 have an area of at least 0.0002 (e.g., at least 0.001, at least 0.01, at least 0.1, at least 1, at least 10, at least 100) cm² and/or at most 600 (e.g., at most 100, at most 10, at most 1, at most 0.01, at most 0.001) cm².

Without wishing to be bound by theory, it is believed that the ratio surface areas of the superhydrophilic regions 1400 to the superhydrophobic regions 1500 can affect the water collection process. For example, a relatively large superhydrophilic area allows for more adhesion by water droplets; however, it also hinders the droplet transport. In certain embodiments, the ratio of the area of the superhydrophilic regions 1400 to the area of the superhydrophobic regions 1500 is at least 1:1 (e.g., at least 2:1, at least 5:1, at least 10:1, at least 100:1, at least 1,000:1) and/or at most 3,000,000:1 (e.g., at most 1,000,000:1, at most 100,000:1, at most 10,000:1, at most 1,000:1, at most 100:1, at most 10:1, at most 5:1, at most 2:1).

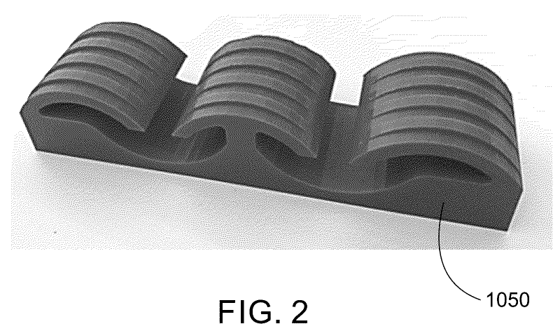

FIG. 2 depicts a computer-generated image of the substrate 1050 made using computer aided design software. The substrate 1050 can be designed in a CAD software and be fabricated using, for example, stereolithography 3D printing to form the base superhydrophobic structure. Superhydrophilic regions could then formed, for example, by selective UV illumination.

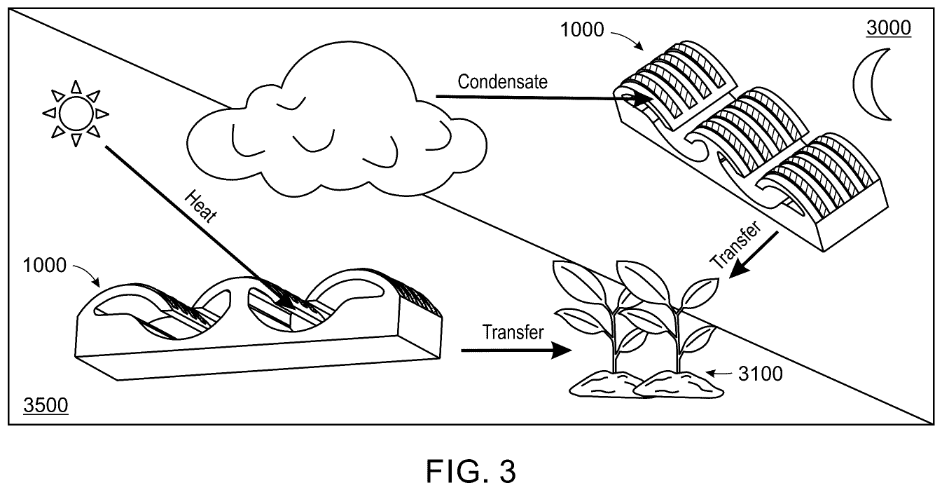

FIG. 3 depicts a schematic for a process of collecting and transferring water using the system 1000. At night 3000, the system 1000 can condense water and transfer the water to a plant 3100. The system 1000 can be configured such that water flows to the plant 3100, for example, under the influence of gravity. Additionally, the temperature-responsive material can absorb water at night 3000. During the day 3500, the temperature-responsive material is heated and can and release the water it previously absorbed. Thus, the system can provide water during both daytime and nighttime.

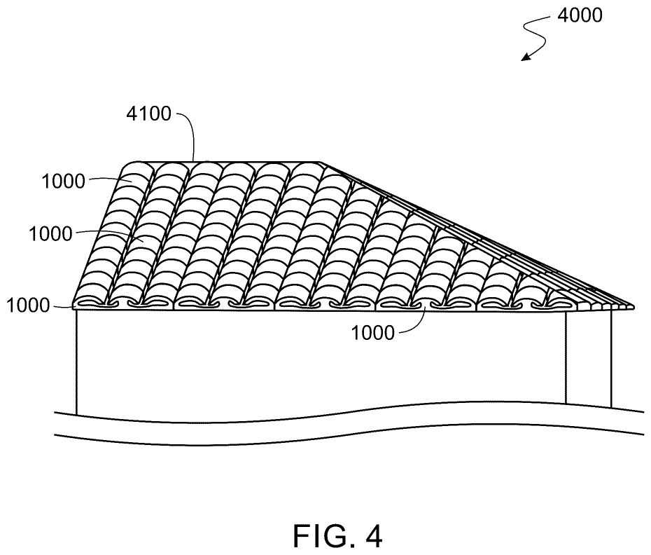

FIG. 4 depicts a schematic for a structure 4000 (e.g., a building or a house). The structure includes a roof 4100 that includes a plurality of systems 1000. Without wishing to be bound by theory, it is believed that the use of the system 1000 on a roof (e.g., as a roof tile) can assist in the function of the system 1000. Specifically, the use of the system 1000 at relatively high elevation, providing the system 1000 with a relatively large area in open air, and/or the incline of the roof promoting the gravity force used to transfer the collected droplets can assist in the collection of water by the system 1000. Without wishing to be bound by theory, it is believed that the concave regions 1110 create a flow channel to facilitate the flow of water. In the structure 4000, the system 1000 is placed at an angle (tilted) such that the water can flow by gravity though the concave regions 1110.

In certain embodiments, the tilt angle of the systems 1000 on the roof 4100 is at least 0° (e.g., at least 5°, at least 10°, at least 15°, at least 20°, at least 25°, at least 30°, at least 35°, at least 40°, at least 45°, at least 50°, at least 55°, at least 60°, at least 65°, at least 70°, at least 75°, at least 80°, at least 85°) and/or at most 90° (e.g., at most 85°, at most 80°, at most 75°, at most 70°, at most 65°, at most 60°, at most 55°, at most 50°, at most 45°, at most 40°, at most 35°, at most 30°, at most 25°, at most 20°, at most 15°, at most 10°, at most 5°).

In some embodiments, the system 1000 and/or the structure 4000 can be used to provide water for plants. Without wishing to be bound by theory, it is believed that the system 1000 and/or the structure 4000 can reduce surface and/or air temperatures by promoting plant growth as the plants can provide shade and evapotranspiration. In some embodiments, the system 1000 and/or the structure 4000 used in combination with plants to provide evapotranspiration and/or shading can reduce temperatures by at 1 (e.g., at least 2, at least 3, at least 4) ° C. and/or at most 5 (e.g., at most 4, at most 3, at most 2) ° C.

### OTHER EMBODIMENTS

While certain embodiments have been disclosed above, the disclosure is not limited to such embodiments.

As example, while embodiments have been disclosed that include the curved surfaces 1300 directly attached to the support body 1100, the disclosure is not limited to such embodiments. For example, in certain embodiments, the curved surfaces 1300 could include one or more intermediate elements (e.g., a protrusion) between the curved surfaces 1300 and the support body 1100 that attach the curved surfaces 1300 to the support body 1100.

What is claimed:

1. A system, comprising:
a substrate comprising a support body, a first curved surface, a second curved surface and a third curved surface;
a plurality of superhydrophilic regions; and
a plurality of superhydrophobic regions,
wherein:
the support body comprises a top surface, a first edge and a second edge opposite the first edge;
the first curved surface, comprises:
a concave side comprising a protrusion attaching the first curved surface to a center of the top surface of the support body; and
a convex side;
the second curved surface comprises a concave side and a convex side;
the second curved surface is attached to the first edge of the support body such that the concave side of the second curved surface faces the top surface of the support body;
the third curved surface comprises a concave side and a convex side;
the third curved surface is attached to the second edge of the support body such that the concave side of the third curved surface faces the top surface of the support body;
the plurality of superhydrophilic regions are supported by the convex side of the first, second and third curved surfaces;
the plurality of superhydrophobic regions are supported by the convex side of the first, second and third curved surfaces; and
the superhydrophilic regions are raised relative to the superhydrophobic regions.

2. The system of claim 1, wherein the plurality of superhydrophilic regions and superhydrophobic regions are arranged in alternating rows parallel to a curvature of the first, second and third curved surfaces.

3. The system of claim 2, wherein the superhydrophilic regions form bumps and the superhydrophobic regions form valleys.

4. The system of claim 3, wherein the superhydrophobic regions have an apex angle of 0° to 90°.

5. The system of claim 1, wherein the top surface of the support body has a concave shape between points of attachment of the protrusion and the second and third curved surfaces.

6. The system of claim 1, wherein the plurality of superhydrophilic regions have a length of 0.01 cm to 40 cm.

7. The system of claim 1, wherein the plurality of superhydrophilic regions have a width of 0.01 cm to 15 cm.

8. The system of claim 1, wherein the plurality of superhydrophobic regions have a surface length of 0.02 cm to 40 cm.

9. The system of claim 1, wherein the plurality of superhydrophobic regions have a width of 0.02 cm to 15 cm.

10. The system of claim 1, wherein the first, second and third curved surfaces comprise a hydrogel disposed on the convex side, wherein:
the hydrogel absorbs water at a first temperature; and
the hydrogel releases absorbed water at a second temperature greater than the first temperature.

11. The system of claim 10, wherein:
the first temperature is less than 32° C.; and
the second temperature is greater than 32° C.

12. The system of claim 1, wherein:
the superhydrophilic regions comprise titanium oxide; and
the superhydrophobic regions comprise heptadecafluorodecyl-trimethoxysilane modified titanium oxide.

13. The system of claim 1, wherein the system has a length of 1.5 cm to 40 cm.

14. The system of claim 1, wherein the system has a width of 1 cm to 26.5 cm.

15. The system of claim 1, wherein the system has a height of 0.05 cm to 2.5 cm.

16. A structure comprising a roof, wherein the roof comprises a plurality of systems according to claim 1.

17. A method of collecting water, using the system of claim 1.

18. A method of collecting water, using the system of claim 10.

19. The method of claim 18, further comprising, absorbing water using the hydrogel at the first temperature.

20. The method of claim 19, further comprising, releasing water absorbed by the hydrogel at the second temperature.
